(19) United States
(12) Patent Application Publication
(10) Pub. No.: US 2020/0079071 A1
(43) Pub. Date: Mar. 12, 2020

(54) POLARIZER ATTACHMENT DEVICE AND POLARIZER PRE-ALIGNMENT DEVICE

(71) Applicant: Zhiyong CAI, Wuhan, Hubei (CN)

(72) Inventor: Zhiyong CAI, Wuhan, Hubei (CN)

(21) Appl. No.: 15/747,514

(22) PCT Filed: Jan. 4, 2018
(86) PCT No.: PCT/CN2018/071382

§ 371 Date: Jan. 25, 2018

(30) Foreign Application Priority Data
Dec. 26, 2017 (CN) 201711434903.0

(51) Int. Cl. B32B 38/18

(52) U.S. Cl. CPC B32B 38/1841; G02B 5/3033

(57) ABSTRACT

The present invention discloses a polarizer pre-alignment device, bottom ends of the first moving alignment member or the second moving alignment member are respectively provided with slits for the base plate of the polarizer cassette can be passed through; the first moving alignment member and/or the second moving alignment member are capable of being folded between a horizontal and vertical angle range, making the polarizer cassette is capable to enter a polarizer pre-alignment station, moving to adjust positions of the first moving alignment member and the second moving alignment member, makes the polarizers in different sizes carried on the polarizer cassette entering the polarizer pre-alignment station is performed the benchmark pre-alignment. The invention also discloses a polarizer attachment device with the polarizer pre-alignment device. The polarizer attachment device and the polarizer pre-alignment device of the present invention can reduce the process flow, improve the pre-alignment efficiency of the polarizer.

### RELATED APPLICATIONS

The present application is a National Phase of International Application Number PCT/CN2018/071382, filed Jan. 4, 2018, and claims the priority of China Application No. 201711434903.0, filed Dec. 26, 2017.

### FIELD OF THE DISCLOSURE

The disclosure relates to a display panel manufacturing technical field, and more particularly to a polarizer attachment device and a polarizer pre-alignment device.

### BACKGROUND

In the conventional technology, the automatic polarizer attachment process of the polarizer attachment device is usually performed according to the following processes: carrying a panel, performing pre-alignment of the panel, transporting the panel and performing fine alignment of the panel; at the same time, the robotic arm takes out the polarizer from the polarizer cassette, cleans the polarizer, removes a releasing film from the polarizer, and performs fine alignment of the polarizer. After that, a serious of process is performed including: performing attachment of the finishing processed polarizer and the panel, transporting, flipping and finally taking out.

In practice, the polarizer is carried in a dedicated polarizer cassette. As shown in FIG. 3, the function of the polarizer cassette 11 is to prevent quality defects such as fractured and scratched when the polarizer is taken out. There is a certain gap between the enclosing members 111 and the polarizer in the polarizer cassette 11. As shown in FIG. 4, the robotic arm 12 takes out the polarizer from the polarizer cassette 11 and places it on the pre-alignment device 13 shown in FIG. 5 for alignment adjustment.

Since the alignment of the polarizer CCD is fine alignment, so that the polarizer CCD has a strict range requirement on the field of vision of the polarizing. If the offset of the polarizer is too much, it will exceed the field of vision of the polarizer CCD and can also lead to the polarizer cannot be crawled. Therefore, in the automatic polarizer attachment process, the polarizer pre-alignment station is a mechanism for performing a certain pre-alignment of the polarizer taken out from the polarizer cassette to ensure that the polarizer can be aligned with the polarizer CCD to be appeared in the normal field of vision.

In the existing automatic polarizer attachment process, the polarizer pre-alignment station is an independent process, which has many problems, such as complicated processes, impacting the efficiency of attachment, complicated structure, difficulty in controlling costs and the like.

### SUMMARY

The technical problem to be solved by the present invention is to provide a polarizer attachment device and a polarizer pre-alignment device, to reduce the process flow, improve the pre-alignment efficiency of the polarizer and improve the productivity; simplify the structure and reduce the product volume, to avoid the abnormal quality conditions during the polarizer is taken out.

In order to solve the above technical problem, an embodiment of the present invention provides a polarizer pre-alignment device for performing pre-alignment to polarizers carried in a polarizer cassette, wherein the polarizer cassette includes a base plate, and the base plate is provided with enclosing members surrounding the polarizers, and further includes: a first fixed stopper for performing a benchmark alignment to short sides of the polarizers; a second fixed stopper for performing the benchmark alignment to long sides of the polarizers, wherein bottom ends of the first fixed stopper and the second fixed stopper are respectively provided with slits for the base plate of the polarizer cassette can be passed through; a first moving alignment member movable for performing the benchmark alignment to the other short sides of the polarizers; a second moving alignment member movable for performing the benchmark alignment to the other long sides of the polarizers; wherein bottom ends of the first moving alignment member or the second moving alignment member are respectively provided with slits for the base plate of the polarizer cassette can be passed through; and the first moving alignment member and/or the second moving alignment member are capable of being folded between a horizontal and vertical angle range, making the polarizer cassette is capable to enter a polarizer pre-alignment station, moving to adjust positions of the first moving alignment member and the second moving alignment member, makes the polarizers in different sizes carried on the polarizer cassette entering the polarizer pre-alignment station is performed the benchmark pre-alignment.

Wherein the first moving alignment member includes a first moving stopper, a first air cylinder connected to the first moving stopper, and a first position adjusting member connected to the first air cylinder, a bottom end of the first moving stopper is provided with a slit, wherein: the first position adjusting member adjusts a position of the first air cylinder in a vertical direction to change in linkage of a height of the slit in the bottom end of the first moving stopper.

Wherein the first air cylinder is linked to the first moving stopper and make the first moving stopper to contact or move away from edges of the short side of an entire column of polarizers stacked on the base plate, and perform the benchmark pre-alignment in the short side direction to the entire column of polarizers stacked on the base plate.

Wherein the second moving alignment member includes a second moving stopper, a second air cylinder connected to the second moving stopper, a rotating shaft is provided between the second moving stopper and the second air cylinder, and by electrically controlling the state of the rotating shaft to perform switching of the second moving stopper between a horizontal direction and a vertical direction.

Wherein the second moving alignment member further includes a second position adjusting member connected to the second air cylinder, the second position adjusting member adjusts a position of the second air cylinder in a vertical direction to change in linkage of a position of a bottom end of the second moving stopper in the vertical direction.

Wherein the second air cylinder is linked to the second moving stopper and make the second moving stopper to contact or move away from edges of the long side of an entire column of polarizers stacked on the base plate, and perform the benchmark pre-alignment in the long side direction to the entire column of polarizers stacked on the base plate.

Wherein a notch is provided at a side edge of the base plate corresponding to the moving track of the second moving alignment member to prevent interference.

Wherein the first fixed stopper and/or the second fixed stopper are inverted U-shaped to prevent interference with the enclosing members.

Wherein heights of the slits of the bottom ends of the first fixed stopper and the second fixed stopper, and a height of the slit of the bottom end of the first moving stopper are respectively equal to the thickness of the base plate.

Wherein the enclosing members are four columns vertically fixed, and are corresponding to the two short sides and two long sides of the polarizers respectively; and relative positions of the four enclosing members disposed to be irregular.

In order to solve the above technical problem, the present invention also discloses a polarizer attachment device with the above-mentioned polarizer pre-alignment device, including: a polarizer pre-alignment device, the polarizer pre-alignment device is for performing pre-alignment to polarizers carried in a polarizer cassette, wherein the polarizer cassette includes a base plate, and the base plate is provided with enclosing members surrounding the polarizers, and further includes: a first fixed stopper for performing a benchmark alignment to short sides of the polarizers; a second fixed stopper for performing the benchmark alignment to long sides of the polarizers, wherein bottom ends of the first fixed stopper and the second fixed stopper are respectively provided with slits for the base plate of the polarizer cassette can be passed through; a first moving alignment member movable for performing the benchmark alignment to the other short sides of the polarizers; a second moving alignment member movable for performing the benchmark alignment to the other long sides of the polarizers; wherein bottom ends of the first moving alignment member or the second moving alignment member are respectively provided with slits for the base plate of the polarizer cassette can be passed through; the first moving alignment member and/or the second moving alignment member are capable of being folded between a horizontal and vertical angle range, making the polarizer cassette is capable to enter a polarizer pre-alignment station, moving to adjust positions of the first moving alignment member and the second moving alignment member, makes the polarizers in different sizes carried on the polarizer cassette entering the polarizer pre-alignment station is performed the benchmark pre-alignment; and the first fixed stopper and/or the second fixed stopper are inverted U-shaped to prevent interference with the enclosing members.

Wherein the first moving alignment member includes a first moving stopper, a first air cylinder connected to the first moving stopper, and a first position adjusting member connected to the first air cylinder, a bottom end of the first moving stopper is provided with a slit, wherein: the first position adjusting member adjusts a position of the first air cylinder in a vertical direction to change in linkage of a height of the slit in the bottom end of the first moving stopper.

Wherein heights of the slits of the bottom ends of the first fixed stopper and the second fixed stopper, and a height of the slit of the bottom end of the first moving stopper are respectively equal to the thickness of the base plate.

Wherein the first air cylinder is linked to the first moving stopper and make the first moving stopper to contact or move away from edges of the short side of an entire column of polarizers stacked on the base plate, and perform the benchmark pre-alignment in the short side direction to the entire column of polarizers stacked on the base plate.

Wherein the second moving alignment member includes a second moving stopper, a second air cylinder connected to the second moving stopper, a rotating shaft is provided between the second moving stopper and the second air cylinder, and by electrically controlling the state of the rotating shaft to perform switching of the second moving stopper between a horizontal direction and a vertical direction.

Wherein the second moving alignment member further includes a second position adjusting member connected to the second air cylinder, the second position adjusting member adjusts a position of the second air cylinder in a vertical direction to change in linkage of a position of a bottom end of the second moving stopper in the vertical direction.

Wherein the second air cylinder is linked to the second moving stopper and make the second moving stopper to contact or move away from edges of the long side of an entire column of polarizers stacked on the base plate, and perform the benchmark pre-alignment in the long side direction to the entire column of polarizers stacked on the base plate.

Wherein a notch is provided at a side edge of the base plate corresponding to the moving track of the second moving alignment member to prevent interference.

The implementation of the polarizer attachment device and the polarizer pre-alignment device provided by the present invention has the following advantages. The bottom ends of the first fixed stopper and second fixed stopper are provided with slits for letting the base plate of the polarizer cassette to be passed through; and further includes the first moving alignment member movable to perform benchmark alignment of the other short side of the polarizer; and the second moving alignment member movable to perform benchmark alignment of the other long side of the polarizer, wherein the bottom ends of the first moving alignment member and the second moving alignment member are provided with slits for letting the base plate of the polarizer cassette to be passed through; the first moving alignment member and/or the second moving alignment member can be folded between the horizontal and vertical angle ranges, so that the polarizer cassette can enter the polarizer pre-alignment station, moving to adjust the position of the first moving alignment member and the second moving alignment member makes the polarizers in different sizes carried on the polarizer cassette entering the polarizer pre-alignment station is performed a benchmark pre-alignment, the process flow can be reduced, the efficiency of the polarizer pre-alignment of can be increased, and the production capacity can be increased; streamline the structure, reduce product size and avoid the abnormal quality conditions easily to be leaded when the polarizers are removed.

### BRIEF DESCRIPTION OF THE DRAWINGS

To describe the technical solutions in the embodiments of the present invention or in the conventional technology more clearly, the following briefly introduces the accompanying drawings required for describing the embodiments or the conventional technology. Apparently, the accompanying drawings in the following description merely show some embodiments of the present invention. For those skilled in the art, other drawings may be obtained based on these drawings without any creative work.

FIG. 1 is a schematic structural diagram of a polarizer pre-alignment device according to an embodiment of the present invention;

FIG. 2 is a schematic structural diagram of the bottom plate of the polarizer cassette of the polarizer pre-alignment device according to the embodiment of the present invention;

FIG. 3 is a schematic structural diagram of a polarizer cassette of the conventional technology;

FIG. 4 is a schematic structural diagram of the conventional technology when the robotic arm takes out the polarizer from the polarizer cassette; and

FIG. 5 is a schematic structural diagram of adjusting the alignment of the polarizer of the pre-alignment device of the conventional technology.

### DETAILED DESCRIPTION OF PREFERRED EMBODIMENTS

The technical solutions in the embodiments of the present invention will be described clearly and completely hereinafter with reference to the accompanying drawings in the embodiments of the present invention. Apparently, the described embodiments are merely some but not all of the embodiments of the present invention. All other embodiments obtained by persons of ordinary skill in the art based on the embodiments of the present invention without creative efforts shall fall within the protection scope of the present invention.

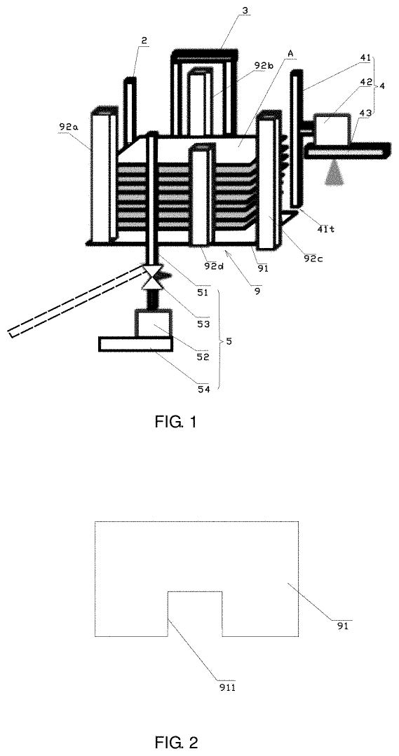

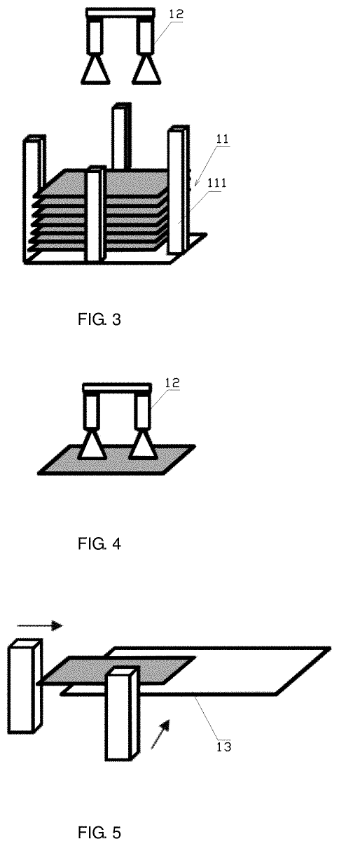

Referring to FIG. 1 to FIG. 2, a first embodiment of a polarizer pre-alignment device according to the present invention is shown.

The polarizer attachment device in this embodiment includes a polarizer pre-alignment device and an image sensing device (not shown), a process during a robotic arm to take out polarizers realizing the pre-alignment from the polarizer pre-alignment device has achieved a fine alignment of the polarizer by recording the polarizer by the image sensing device.

The polarizer pre-alignment device in this embodiment is possible to perform the pre-alignment to an entire column of polarizers A carried in the polarizer cassette 9. The polarizer cassette 9 is a special device for carrying the polarizers. The purpose of the polarizer cassette 9 is to prevent the polarizers from being fractured, scratched and the like which may affect the quality during the taking out process. Each polarizer A in this embodiment has a rectangular shape with two opposite long sides and two opposite short sides.

The polarizer cassette 9 in this embodiment includes a base plate 91, the entire column of polarizers A is stacked on the base plate 91, and the base plate 91 is provided with enclosing members surrounding the polarizers A; in this embodiment, the enclosing members are four columns 92a, 92b, 92c, 92d vertically arranged, and the four columns 92a, 92b, 92c, 92d are correspondingly and respectively disposed on two opposite short sides and two opposite long sides of the polarizers A, and has certain gaps with the edges of the polarizers A.

Preferably, the relative positions of the four enclosing members 92a, 92b, 92c and 92d are set to be irregular. For example, the connecting line between the two enclosing members 92a and 92c disposed on the two opposite short sides of the polarizer A intersects with the long sides of the polarizers A; the connecting line between the two enclosing members 92b and 92d provided on the opposite sides of the two long sides of the polarizer A intersects with the short side of the polarizer A. In this way, the enclosing members 92a, 92b, 92c, and 92d can be avoided from other structural components for realizing the pre-alignment of the polarizer pre-alignment device, for example, a first fixed stopper 2, a first moving alignment member 4, a second moving alignment member 5, etc. to prevent interference during operation.

Preferably, a notch 911 is provided at a side edge of the base plate 91 corresponding to the moving track of a second moving alignment member, so as to prevent interference of the polarizer cassette 9 and the pre-alignment structural components during performing the polarizer pre-alignment, that is prevent interference with the second moving alignment member 5.

The polarizer pre-alignment device in this embodiment further includes: the first fixed stopper 2 for aligning the short side of the polarizer A, and a second fixed stopper 3 for aligning the long side of the polarizer A. The first fixed stopper 2 and the second fixed stopper 3 in the present embodiment are vertically arranged cylinders and are fastened on the polarizer pre-alignment station. The function of the first fixed stopper 2 and the second fixed stopper 3 are serving as benchmarks for respectively contacting an edge of the short side of the polarizer A and an edge of the long side of the polarizer.

Further, bottom ends of the first fixed stopper 2 and the second fixed stopper 3 are respectively provided with slits, the type of the slits may be formed in the first fixed stopper 2 and the second fixed stopper 3, or may be formed by suspending the first fixed stopper 2 and the second fixed stopper 3. The function of the slits is that during the process of the polarizer cassette 9 entering the polarizer pre-alignment station, letting the base plate 91 of the polarizer cassette 9 to be passed through to achieve the alignment.

Preferably, the height of the slits provided at the bottom ends of the first fixed stopper 2 and the second fixed stopper 3 is equal to the thickness of the bottom plate 91. In this way, after the base plate 91 of the polarizer cassette 9 passes through the slits, the first fixed stopper 2 and the second fixed stopper 3 can block the entire column of the polarizer A on the base plate 91. Preferably, the overall shape of the second fixed stopper 3 is inverted U-shaped, and the hollow area is capable of accommodating the enclosing members of the polarizer cassette 9 during the polarizer cassette 9 entering the polarizer pre-alignment station, to prevent interference with the enclosing members. In other embodiments, the first fixed stopper can also be configured as such kind of structure.

The polarizer pre-alignment device in this embodiment further includes: a first moving alignment member 4 that is movable to perform the benchmark alignment to the other short side of the polarizer A, and the second moving alignment member 5 that is movable to perform the benchmark alignment to the other long side of the polarizer A, wherein: by controlling the relative positions of the first moving alignment member 4 and the second moving alignment member 5 with the polarizer A, for example, during the process of the first moving alignment member 4 and the second moving alignment member 5 respectively moving to come into contact with the edge of the other short side of the polarizer A and the edge of the other long side, and the first moving alignment member 4 and the second moving alignment member 5 respectively moving away from the edge of the other short side of the polarizer A and the edge of the other long edge, to achieve the pre-alignment of the entire column of the polarizer A in the polarizer cassette 9. The structure of the first moving alignment member 4 and the second moving alignment member 5 and the process of implementing the pre-alignment are described in detail as follows.

In this embodiment, the first moving alignment member 4 includes a first moving stopper 41, a first air cylinder 42 connected to the first moving stopper 41, and a first position adjusting member 43 connected to the first air cylinder 42, a bottom end of the first moving stopper 41 is provided with a slit 41t, wherein: the first position adjusting member 43 adjusts a position of the first air cylinder 42 in the vertical direction to change in linkage of the height of the slit 41t of the bottom end of the first moving stopper 41. The first position adjusting member 43 in this embodiment is a cylinder position adjusting bracket.

Preferably, a height of the slit 41t in the bottom end of the first moving stopper 41 is equal to the thickness of the base plate 91, respectively. In this way, after the base plate 91 of the polarizer cassette 9 passes through the slit 41t, the first moving stopper 41 can contact the entire column of polarizers A on the base plate 91.

Further, the second moving alignment member 5 includes a second moving stopper 51 and a second air cylinder 52 connected to the second moving stopper 51, a rotating shaft 53 is provided between the second moving stopper 51 and the second air cylinder 52, The function of the rotating shaft 53 is to switch the second moving stopper 51 between the horizontal direction and the vertical direction by the state of the rotating shaft 53 electrically. That is, the second moving alignment member 51 can be vertically inverted and can achieve locking, can be folded between the horizontal and vertical angle range, so that the polarizer cassette 9 can enter the polarizer pre-alignment device.

Preferably, the second moving alignment member 5 further includes a second position adjusting member 54 connected to the second air cylinder 52, and the second position adjusting member 54 adjusts the position of the second air cylinder 52 in the vertical direction to change in linkage of the bottom end position of the second moving stopper 51 in the vertical direction, to accommodate different sizes of polarizers. The second position adjusting member 54 in this embodiment is a cylinder position adjusting bracket.

In a specific implementation, the positions of the first moving alignment member 4 and the second moving alignment member 5 are moved to adjust, so that the polarizers A in different sizes carried on the polarizer cassette 9 entering the polarizer pre-alignment station is performed a benchmark pre-alignment. Specifically, the first air cylinder 42 linking with the first moving stopper 41 makes the first moving stopper 41 to contact or move away from the edge of the short side of the entire column of polarizers A stacked on the base plate, and perform the benchmark pre-alignment in the short side direction of the polarizers A. At the same time, the second air cylinder 52 linking with the second moving stopper 51 makes the second moving stopper 51 to contact or move away from the edge of the long edge of the entire column if polarizers A stacked on the base plate, and perform the benchmark pre-alignment in the long side direction of the polarizers A.

In the specific implementation of the polarizer pre-alignment device in this embodiment, firstly, the first moving stopper 41 of the first moving alignment member 4 and the second moving stopper 51 of the second moving alignment member 5 are turned on by the respective cylinders, that is, away from the first fixed stopper 2 and the second fixed stopper 3, respectively. The rotating shaft 53 on the second moving stopper 51 is controlled, the second moving stopper 51 is tilted to 0 degrees (a dotted line status as shown in the FIG.), and the polarizer cassette 9 as a whole enters the polarizer pre-alignment device.

Next, after the polarizer cassette 9 as a whole is completely placed, the rotating shaft 53 on the second moving stopper 51 is controlled to make the second moving stopper 51 back to the vertical state of 90 degrees and to be locked, to ensure that the second moving stopper 51 vertical motionless. After that, the first moving stopper 41 of the first moving alignment member 4 and the second moving stopper 51 of the second moving alignment member 5 are turned off by the respective cylinders, that is, the first moving alignment member 4 and the second moving alignment member 5 are respectively moved to come into contact with the edge of the other short side and the edge of the other long side of the of the polarizer A.

Before the polarizers A is removed by the robotic arm, by the respectively controlling of the first air cylinder 42 to the first moving alignment member 4 and the second air cylinder 52 to the second moving alignment member 5, so that the first moving alignment member 4 and the second moving alignment member 5 are respectively moved to contact with the edges of the other short side and the other long side of the polarizers A, and the first moving alignment member 4 and the second moving alignment member 5 are respectively moved away from the edges of the other short side and the other long side of the polarizers A, by repeating the above process to achieve the neatly arranged of polarizers. Finally, the first moving alignment member 4 and the second moving alignment member 5 respectively move to contact with the edges of the other short side and the other long side of the polarizers A, and the robotic arm descends to pick up the polarizer, after the polarizer is confirmed to be sucked, the first moving alignment member 4 and the second moving alignment member 5 are opened, the robotic arm draws the polarizer up, to ensure when the polarizer is taken out, it does not interfere with the first moving alignment member 4 and the second moving alignment member 5.

The implementation of the polarizer attachment device and the polarizer pre-alignment device provided by the present invention has the following advantages. The bottom ends of the first fixed stopper and second fixed stopper are provided with slits for letting the base plate of the polarizer cassette to be passed through; and further includes the first moving alignment member movable to perform benchmark alignment of the other short side of the polarizer; and the second moving alignment member movable to perform benchmark alignment of the other long side of the polarizer, wherein the bottom ends of the first moving alignment member and the second moving alignment member are provided with slits for letting the base plate of the polarizer cassette to be passed through; the first moving alignment member and/or the second moving alignment member can be folded between the horizontal and vertical angle ranges, so that the polarizer cassette can enter the polarizer pre-alignment station, moving to adjust the position of the first moving alignment member and the second moving alignment member makes the polarizers in different sizes carried on the polarizer cassette entering the polarizer pre-alignment station is performed a benchmark pre-alignment, the process flow can be reduced, the efficiency of the polarizer pre-alignment of can be increased, and the production capacity can be increased; streamline the structure, reduce product size and avoid the abnormal quality conditions easily to be leaded when the polarizers are removed.

What is claimed is:

1. A polarizer pre-alignment device for performing pre-alignment to polarizers carried in a polarizer cassette, wherein the polarizer cassette comprises a base plate, and the base plate is provided with enclosing members surrounding the polarizers, and further comprises:
a first fixed stopper for performing a benchmark alignment to short sides of the polarizers;
a second fixed stopper for performing the benchmark alignment to long sides of the polarizers, wherein bottom ends of the first fixed stopper and the second fixed stopper are respectively provided with slits for the base plate of the polarizer cassette can be passed through;
a first moving alignment member movable for performing the benchmark alignment to the other short sides of the polarizers;
a second moving alignment member movable for performing the benchmark alignment to the other long sides of the polarizers;
wherein bottom ends of the first moving alignment member or the second moving alignment member are respectively provided with slits for the base plate of the polarizer cassette can be passed through; and
the first moving alignment member and/or the second moving alignment member are capable of being folded between a horizontal and vertical angle range, making the polarizer cassette is capable to enter a polarizer pre-alignment station, moving to adjust positions of the first moving alignment member and the second moving alignment member, makes the polarizers in different sizes carried on the polarizer cassette entering the polarizer pre-alignment station is performed the benchmark pre-alignment.

2. The polarizer pre-alignment device according to claim 1, wherein the first moving alignment member comprises a first moving stopper, a first air cylinder connected to the first moving stopper, and a first position adjusting member connected to the first air cylinder, a bottom end of the first moving stopper is provided with a slit, wherein: the first position adjusting member adjusts a position of the first air cylinder in a vertical direction to change in linkage of a height of the slit in the bottom end of the first moving stopper.

3. The polarizer pre-alignment device according to claim 2, wherein the first air cylinder is linked to the first moving stopper and make the first moving stopper to contact or move away from edges of the short side of an entire column of polarizers stacked on the base plate, and perform the benchmark pre-alignment in the short side direction to the entire column of polarizers stacked on the base plate.

4. The polarizer pre-alignment device according to claim 1, wherein the second moving alignment member comprises a second moving stopper, a second air cylinder connected to the second moving stopper, a rotating shaft is provided between the second moving stopper and the second air cylinder, and by electrically controlling the state of the rotating shaft to perform switching of the second moving stopper between a horizontal direction and a vertical direction.

5. The polarizer pre-alignment device according to claim 3, wherein the second moving alignment member comprises a second moving stopper, a second air cylinder connected to the second moving stopper, a rotating shaft is provided between the second moving stopper and the second air cylinder, and by electrically controlling the state of the rotating shaft to perform switching of the second moving stopper between a horizontal direction and a vertical direction.

6. The polarizer pre-alignment device according to claim 4, wherein the second moving alignment member further comprises a second position adjusting member connected to the second air cylinder, the second position adjusting member adjusts a position of the second air cylinder in a vertical direction to change in linkage of a position of a bottom end of the second moving stopper in the vertical direction.

7. The polarizer pre-alignment device according to claim 4, wherein the second air cylinder is linked to the second moving stopper and make the second moving stopper to contact or move away from edges of the long side of an entire column of polarizers stacked on the base plate, and perform the benchmark pre-alignment in the long side direction to the entire column of polarizers stacked on the base plate.

8. The polarizer pre-alignment device according to claim 4, wherein a notch is provided at a side edge of the base plate corresponding to the moving track of the second moving alignment member to prevent interference.

9. The polarizer pre-alignment device according to claim 1, wherein the first fixed stopper and/or the second fixed stopper are inverted U-shaped to prevent interference with the enclosing members.

10. The polarizer pre-alignment device according to claim 2, wherein heights of the slits of the bottom ends of the first fixed stopper and the second fixed stopper, and a height of the slit of the bottom end of the first moving stopper are respectively equal to the thickness of the base plate.

11. The polarizer pre-alignment device according to claim 1, wherein the enclosing members are four columns vertically fixed, and are corresponding to the two short sides and two long sides of the polarizers respectively; and
relative positions of the four enclosing members disposed to be irregular.

12. A polarizer attachment device, wherein the polarizer attachment device comprises a polarizer pre-alignment device, the polarizer pre-alignment device is for performing pre-alignment to polarizers carried in a polarizer cassette, wherein the polarizer cassette comprises a base plate, and the base plate is provided with enclosing members surrounding the polarizers, and further comprises:
a first fixed stopper for performing a benchmark alignment to short sides of the polarizers;
a second fixed stopper for performing the benchmark alignment to long sides of the polarizers, wherein bottom ends of the first fixed stopper and the second fixed stopper are respectively provided with slits for the base plate of the polarizer cassette can be passed through;
a first moving alignment member movable for performing the benchmark alignment to the other short sides of the polarizers;
a second moving alignment member movable for performing the benchmark alignment to the other long sides of the polarizers;
wherein bottom ends of the first moving alignment member or the second moving alignment member are respectively provided with slits for the base plate of the polarizer cassette can be passed through;
the first moving alignment member and/or the second moving alignment member are capable of being folded between a horizontal and vertical angle range, making the polarizer cassette is capable to enter a polarizer pre-alignment station, moving to adjust positions of the first moving alignment member and the second moving alignment member, makes the polarizers in different sizes carried on the polarizer cassette entering the polarizer pre-alignment station is performed the benchmark pre-alignment; and
the first fixed stopper and/or the second fixed stopper are inverted U-shaped to prevent interference with the enclosing members.

13. The polarizer attachment device according to claim 12, wherein the first moving alignment member comprises a first moving stopper, a first air cylinder connected to the first moving stopper, and a first position adjusting member connected to the first air cylinder, a bottom end of the first moving stopper is provided with a slit, wherein: the first position adjusting member adjusts a position of the first air cylinder in a vertical direction to change in linkage of a height of the slit in the bottom end of the first moving stopper.

14. The polarizer attachment device according to claim 13, wherein heights of the slits of the bottom ends of the first fixed stopper and the second fixed stopper, and a height of the slit of the bottom end of the first moving stopper are respectively equal to the thickness of the base plate.

15. The polarizer attachment device according to claim 14, wherein the first air cylinder is linked to the first moving stopper and make the first moving stopper to contact or move away from edges of the short side of an entire column of polarizers stacked on the base plate, and perform the benchmark pre-alignment in the short side direction to the entire column of polarizers stacked on the base plate.

16. The polarizer attachment device according to claim 15, wherein the second moving alignment member comprises a second moving stopper, a second air cylinder connected to the second moving stopper, a rotating shaft is provided between the second moving stopper and the second air cylinder, and by electrically controlling the state of the rotating shaft to perform switching of the second moving stopper between a horizontal direction and a vertical direction.

17. The polarizer attachment device according to claim 16, wherein the second moving alignment member further comprises a second position adjusting member connected to the second air cylinder, the second position adjusting member adjusts a position of the second air cylinder in a vertical direction to change in linkage of a position of a bottom end of the second moving stopper in the vertical direction.

18. The polarizer attachment device according to claim 16, wherein the second air cylinder is linked to the second moving stopper and make the second moving stopper to contact or move away from edges of the long side of an entire column of polarizers stacked on the base plate, and perform the benchmark pre-alignment in the long side direction to the entire column of polarizers stacked on the base plate.

19. The polarizer attachment device according to claim 16, wherein a notch is provided at a side edge of the base plate corresponding to the moving track of the second moving alignment member to prevent interference.
